(19) United States
(12) Patent Application Publication
(10) Pub. No.: US 2008/0034643 A1
(43) Pub. Date: Feb. 14, 2008

(54) Electric insect killer with illuminating capability

(76) Inventor: Chi-Wen Chen, Taipei City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/717,336

(22) Filed: Mar. 12, 2007

(30) Foreign Application Priority Data
Aug. 14, 2006 (CN) 200620130691.8

(51) Int. Cl. A01M 1/22; A01M 1/04

(52) U.S. Cl. 43/112; 43/113

(57) ABSTRACT

An electric insect killer includes a housing, an insect attracting and killing module, an illuminating module, and a power supplying module. The insect attracting and killing module is coupled to the housing and includes a light source for generating light to attract insects, and a high voltage grid unit surrounding the light source and operable to electrocute the insects attracted to the light source. The illuminating module is mounted on the housing for emitting illuminating light. The power supplying module is mounted in the housing, and is coupled electrically to the light source, the high voltage grid unit, and the illuminating module for supplying electric power thereto.

### CROSS-REFERENCE TO RELATED APPLICATION

This application claims priority of Chinese Application No. 200620130691.8, filed on Aug. 14, 2006.

### BACKGROUND OF THE INVENTION

1. Field of the Invention

The invention relates to an insect killer, more particularly to an electric insect killer with illuminating capability.

2. Description of the Related Art

A conventional electric insect killer suitable for outdoor use, such as during night activities and field camping, includes an insect attracting lamp for generating light to attract insects, and a high voltage grid for electrocuting the insects attracted to the light. However, since illuminating intensity of the light generated by the insect attracting lamp is not great enough, the conventional electric insect killer is not suitable for illuminating purposes such that a user needs to carry both the conventional electric insect killer and an illuminating device during outdoor activities. In addition, the conventional electric insect killer is usually bulky and is not portable.

### SUMMARY OF THE INVENTION

Therefore, the object of the present invention is to provide an electric insect killer that is provided with illuminating capability.

According to the present invention, there is provided an electric insect killer includes a housing, an insect attracting and killing module, an illuminating module, and a power supplying module. The insect attracting and killing module is coupled to the housing and includes a light source for generating light to attract insects, and a high voltage grid unit surrounding the light source and operable to electrocute the insects attracted to the light source. The illuminating module is mounted on the housing for emitting illuminating light. The power supplying module is mounted in the housing, and is coupled electrically to the light source, the high voltage grid unit, and the illuminating module for supplying electric power thereto.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of an electric insect killer according to the present invention, illustrating a drive arm operable to rotate relative to a housing;

FIG. 2 is an exploded perspective view of the preferred embodiment;

FIG. 3 is a fragmentary sectional view of the preferred embodiment, illustrating structural relationship between a positioning member and a positioning part;

FIG. 4 is a fragmentary enlarged exploded perspective view of the preferred embodiment, illustrating coupling relationship between an illuminating module and a housing;

FIG. 5 is a sectional view of the preferred embodiment, illustrating a retracted position of an insect attracting and killing module;

FIG. 6 is another sectional view of the preferred embodiment, illustrating an extended position of the insect attracting and killing module; and

FIG. 7 is a perspective view of the preferred embodiment, illustrating an illuminating lamp pivoted relative to a pivot seat of the illuminating module.

### DETAILED DESCRIPTION OF THE PREFERRED EMBODIMENT

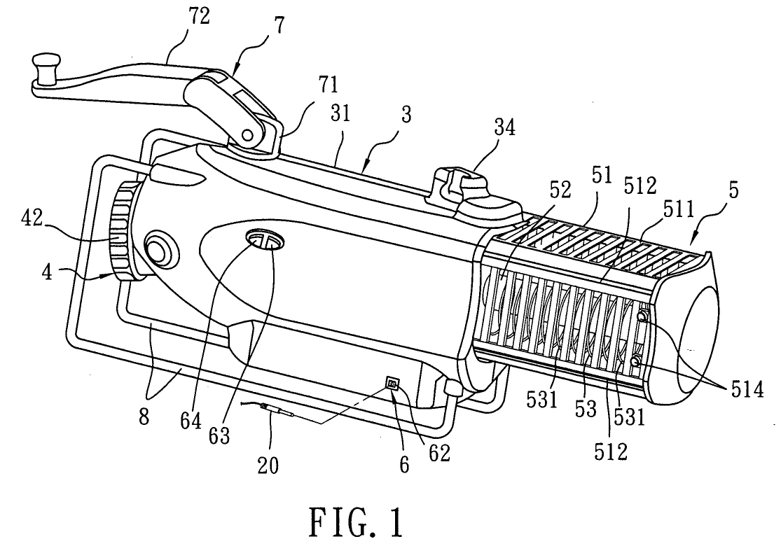

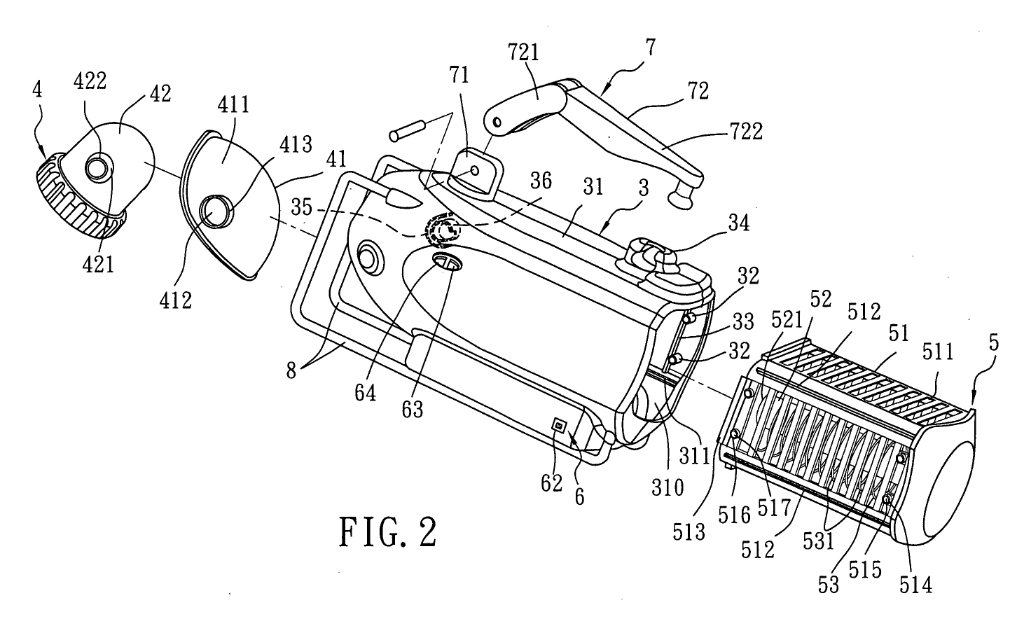

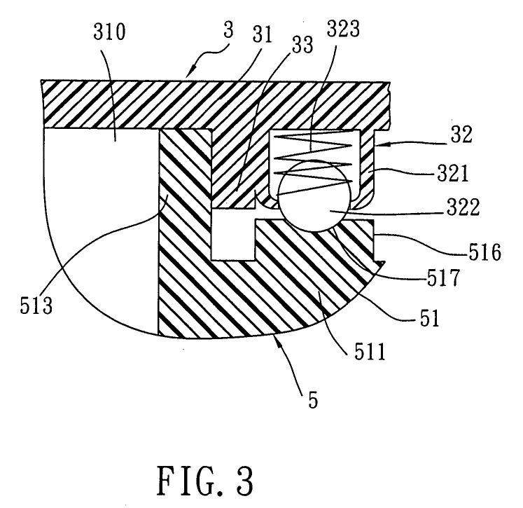

As shown in FIG. 1, FIG. 2 and FIG. 3, the preferred embodiment of an electric insect killer according to the present invention is adapted to be connected electrically to a cigarette lighter socket (not shown) of a vehicle (not shown) via a cable 20 such that the electric insect killer can be charged by a direct current power source of the vehicle. In addition, the electric insect killer according to the preferred embodiment can be held by one hand, and includes a housing 3 to be held by a user's hand, an illuminating module 4 mounted pivotally to the housing 3, an insect attracting and killing module 5 coupled to the housing 3, a power supplying module 6 mounted in the housing 3 and connected electrically to the illuminating module 4 and the insect attracting and killing module 5, a power generator 7 mounted to the housing 3 and connected electrically to the power supplying module 6, and two frame members 8 mounted on the housing 3.

The housing 3 includes a housing body 31 defining a mounting space 310, four positioning members 32 provided symmetrically on a rear end part of the housing body 31 and extending into the mounting space 310, a pair of first limiting ribs 33 projecting from the rear end part of the housing body 31 into the mounting space 310 and spaced apart from each other, a C-shaped anchoring seat 34 provided on a top side of the housing body 31 and opening toward the left, a pair of limiting plates 35 projecting from a front end part of the housing body 31 and extending into the mounting space 310, and two conductive pivot shafts 36 projecting from the housing body 310 into the mounting space 310 and surrounded by the limiting plates 35, respectively.

The housing body 31 is formed with four symmetrically-disposed slide grooves 311 that extend in a longitudinal direction and that are in spatial communication with the mounting space 310. Pairs of the positioning members 32 are registered with each other. As best illustrated in FIG. 3, each of the positioning members 32 includes a mounting tube 321 projecting from the housing body 31 into the mounting space 310, a ball-shaped engaging element 322 movably disposed in the mounting tube 321, and a biasing element 323 received in the mounting tube 321 and biasing the engaging element 322 such that an end part of the engaging element 322 extends out of the mounting tube 321. In this embodiment, the biasing element 323 is a spring, but should not be limited thereto in other embodiments of the present invention. Each of the first limiting ribs 33 is disposed proximate to a front end of the mounting tube 321 of a respective pair of the positioning members 32.

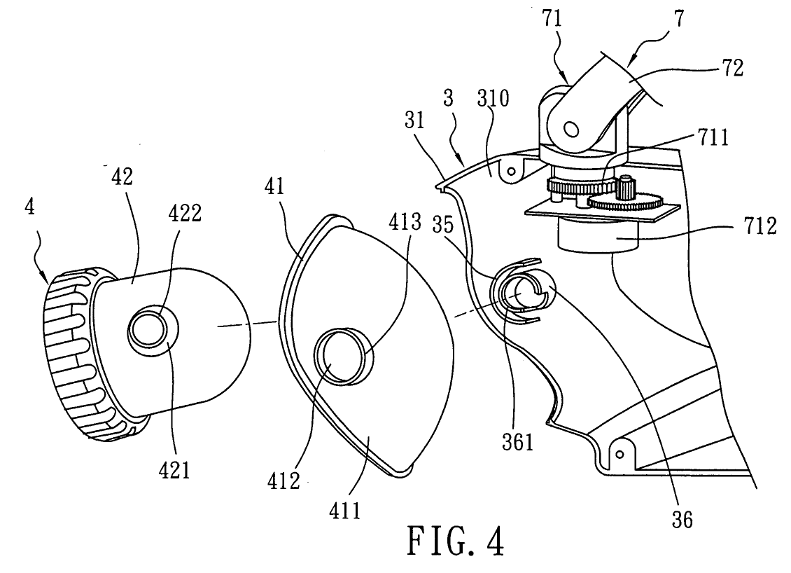

Referring to FIG. 4, each of the limiting plates 35 forms a semi-circular arc that opens rearwardly. Each of the conductive pivot shafts 36 is provided with an annular conductive part 361 at an edge thereof that is connected electrically to the power supplying module 6.

The illuminating module 4 includes a bowl-shaped pivot seat 41 mounted to the front end part of the housing body 31, and an illuminating lamp 42 pivoted to the pivot seat 41. The pivot seat 41 includes a bowl-shaped seat body 411 that opens forwardly, that is mounted in the mounting space 310, and that covers a front opening of the housing body 31, and two limiting ring parts 413 (only one is visible in the drawings) that project from the seat body 411 and that are opposite to each other. The limiting ring parts 413 are sleeved respectively on the conductive pivot shafts 36 such that each of the limiting ring parts 413 is clamped by a respective pair of the conductive pivot shafts 36 and the limiting plates 35, thereby mounting the pivot seat 41 to the front end part of the housing body 31. In addition, the seat body 411 has a curved inner surface, and is formed with two pivot holes 412 therethrough. Each of the limiting ring parts 413 extends outwardly from the periphery of a respective one of the pivot holes 412.

The lamp 42 has two pivot ring parts 421, each of which extends rotatably into a respective one of the pivot holes 412, and a pair of conductive contact parts 422, each of which is surrounded by a respective one of the pivot ring parts 421 and contacts electrically the annular conductive part 361 of a respective one of the conductive pivot shafts 36 of the housing 3. In this embodiment, the illuminating lamp 42 includes a plurality of light-emitting diodes (LEDs) (not shown) for emitting illuminating light, and permits multi-level adjustments to illuminating intensity thereof. However, the illuminating lamp 42 can utilize other types of light-generating sources in other embodiments of the present invention.

Referring once again to FIG. 1, FIG. 2 and FIG. 3, the insect attracting and killing module 5 includes a tubular fence 51 connected telescopically to the housing 3, a light source 52 mounted in the tubular fence 51 for generating light to attract insects, and a high voltage grid unit 53 mounted in the tubular fence 51, surrounding the light source 52, and operable to electrocute the insects attracted to the light source 52. The tubular fence 51 includes a fence body 511 that extends into the mounting space 310, that is movable into and out of the mounting space 310, and that is formed with a plurality of holes to permit insects to fly therein. The tubular fence 51 further includes four symmetrically-disposed guide ribs 512, two second limiting ribs 513, four first positioning parts 514, and four second positioning parts 516. The guide ribs 512 are coupled slidably and respectively to the slide grooves 311 in the housing body 31. The second limiting ribs 513 project from a front end of the fence body 511. The first positioning parts 514 are provided on a rear end of the fence body 511, while the second positioning parts 516 are provided on the front end of the fence body 511. Each of the first and second positioning parts 514, 516 is formed with a positioning groove 515, 517 to engage releasably the end part of the engaging element 322 of the positioning member 32.

In this embodiment, the light source 52 of the insect attracting and killing module 5 includes a light-transmissive tubular body 521 and a plurality of light-emitting components (not shown) disposed in the light-transmissive tubular body 521. The light-emitting components are capable of radiating light within a wavelength range of 370 to 430 nm so as to attract insects of various kinds. However, during implementation, the light radiated by the light source 52 is not limited to being within this particular range of wavelengths, and can be adjusted as required. The high voltage grid unit 53 includes a plurality of annular conductive grid elements 531 that surround the light source 52, and that are spacedly arranged along the light source 52. Present across each adjacent pair of the grid elements 531 is a high voltage difference that is capable of electrocuting an insect instantly when the insect simultaneously touches the adjacent pair of grid elements 531. During implementation, the grid elements 531 can be designed to be elongated structures that extend in the longitudinal direction, and are not limited to the particular configuration described herein.

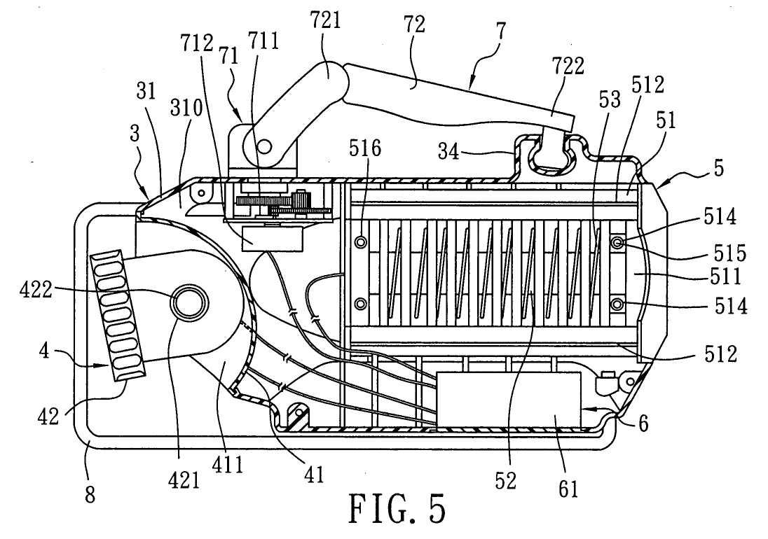

As shown in FIG. 1, FIG. 2 and FIG. 5, the power supplying module 6 includes a power storing unit 61 mounted in the housing 3 and including rechargeable batteries (not shown), and a power receptacle 62 and first and second on/off button switches 63, 64 mounted to a left side of the housing 3, accessible externally of the housing 3, and connected electrically to the power storing unit 61. The first on/off button switch 63 is operable to enable the power storing unit 61 to deliver the electricity stored therein to the light source 52 and the high voltage grid unit 53 of the insect attracting and killing module 5. The second on/off button switch 64 is operable to enable the power storing unit 61 to deliver the electricity stored therein to the illuminating lamp 42 of the illuminating module 4. The power receptacle 62 is adapted to be connected to an external power source, such as a cigarette lighter socket of a vehicle, via the cable 20 so as to permit storage of electricity from the external power source in the power storing unit 61.

The power generator 7 includes a power generating member 71 mounted in the housing 3 and connected electrically to the power storing unit 61, and a drive arm 72 accessible externally of the housing 3, coupled to the power generating member 71, and operable to drive the power generating member 71 to generate electricity that is to be stored in the power storing unit 61. As shown in FIG. 4 and FIG. 5, the power generating member 71 of this embodiment includes a transmission gear unit 711 mounted in the housing 3 and coupled to and driven by the drive arm 72, and a generator component 712 mounted in the housing 3, connected electrically to the power storing unit 61, and coupled to and driven by the transmission gear unit 71 to generate electricity via magnetic induction in a known manner. The drive arm 72 is manually operable to rotate relative to the housing 3 to drive the transmission gear unit 711, and includes a pivot segment 721 connected pivotally to the transmission gear unit 71, and a handle segment 722 connected pivotally to an end of the pivot segment 721 and having an end part that engages removably the anchoring seat 34 of the housing 3.

The frame members 8 are disposed symmetrically to each other, and are bent into corners such that opposite ends of each of the frame members 8 are fixed to front and rear parts of the housing body 31, respectively. However, the frame members 8 may be omitted in other embodiments of the present invention.

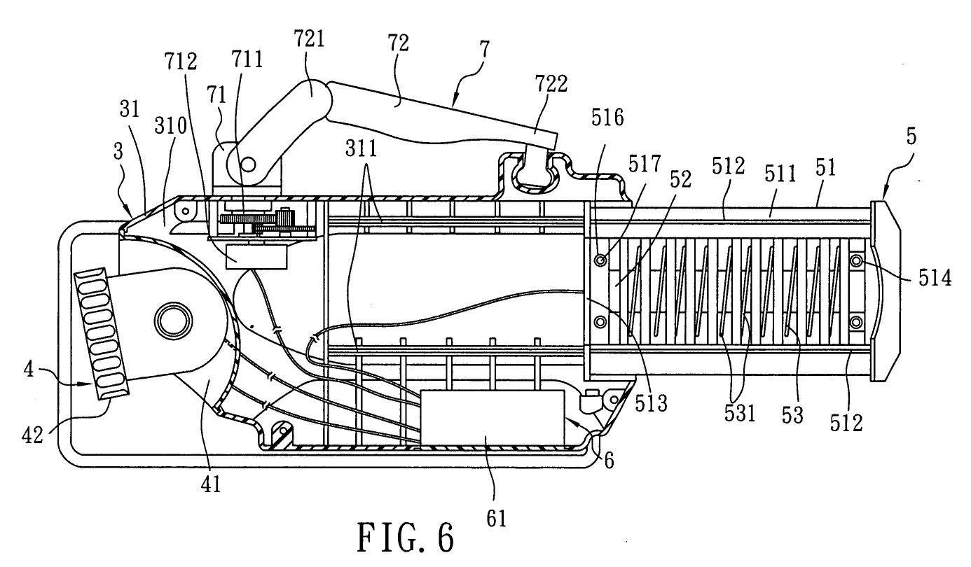

When the electric insect killer is fully assembled, the tubular fence 51 is connected telescopically to the housing 3 such that the insect attracting and killing module 5 is movable between a retracted position, where the tubular fence 51 is concealed in the housing 3 as illustrated in FIG. 5, and an extended position, where the tubular fence 51 extends out of the housing 3 as illustrated in FIG. 1 and FIG. 6. As shown in FIG. 2 and FIG. 5, the first positioning parts 514 engage releasably the positioning members 32 when the insect attracting and killing module 5 is at the retracted position. In particular, the engaging elements 322 (see FIG. 3) of the positioning members 32 extend into the positioning grooves 515 in the first positioning parts 514, respectively, by virtue of biasing action of the biasing elements 323 (see FIG. 3).

As shown in FIG. 2, FIG. 3 and FIG. 6, when it is desired to move the tubular fence 51 from the retracted position to the extended position, the tubular fence 51 needs to be pulled rearwardly relative to the housing body 31 such that the engaging elements 322 of the positioning members 32 are removed from the first positioning parts 514 and such that the guide ribs 512 slide respectively in the slide grooves 311 along the housing body 31. The tubular fence 51 is extended out of the housing body 31 in this manner until the second limiting ribs 513 abut against the first limiting ribs 33, respectively, to prevent separation of the insect attracting and killing module 5 from the housing 3. At this time, the second positioning parts 516 engage releasably the positioning members 32. In particular, the engaging elements 322 of the positioning members 32 extend into the positioning grooves 517 in the second positioning parts 516, respectively, by virtue of biasing action of the biasing elements 323. Next, by pressing the first on/off button switch 63, the light source 52 of the insect attracting and killing module 5 is activated to generate the light for attracting insects. At the same time, electricity also passes through the annular conductive grid elements 531 of the high voltage grid unit 53.

When an insect enters into the fence body 511 and contacts of an adjacent pair of the grid elements 531, the insect is electrocuted by the high voltage difference present between the adjacent grid elements 531. When the insect attracting and killing function is no longer required, the first on/off button switch 63 is simply pressed to turn off electricity supplied to the light source 52 and the high voltage grid unit 53 by the power storing unit 61. The tubular fence 51 can then be moved forwardly relative to the housing body 31 until the insect attracting and killing module 5 reaches the retracted position (as shown in FIG. 5), where the engaging elements 322 of the positioning members 32 engage the positioning grooves 515 in the first positioning parts 514, respectively.

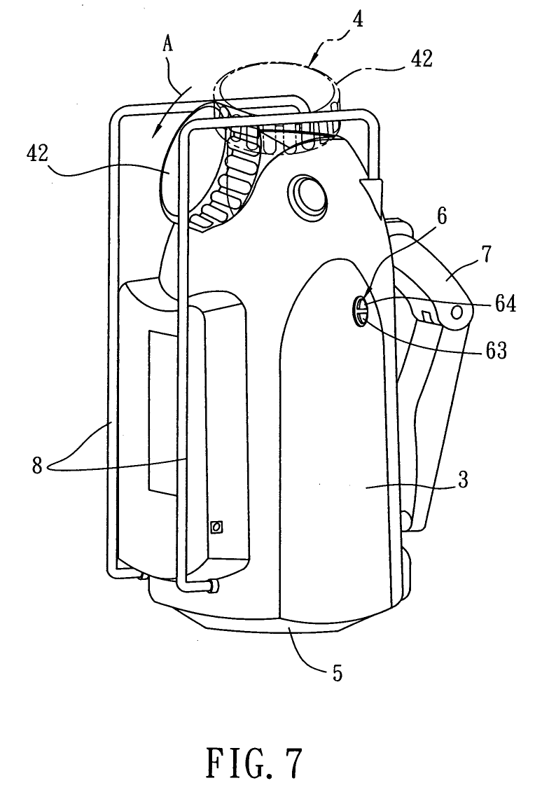

As shown in FIG. 7, when it is desired to use the illuminating module 4, the second on/off button switch 64 is pressed to permit supply of electricity to the illuminating lamp 42 so as to activate the latter. Preferably, the illuminating intensity of illuminating lamp 42 can be varied through repeated pressing of the second on/off button switch 64. For example, the illuminating intensity of the illuminating lamp 42 can be adjusted in levels by turning on only a portion of the light-emitting diodes of the illuminating lamp 42, by turning on all of the light-emitting diodes, or by turning off all of the light-emitting diodes, etc. However, operation of the second on/off button switch 64 and the illuminating lamp 42 is not limited to the examples provided hereinabove during actual implementation. In addition, since the illuminating lamp 42 can pivot relative to the pivot seat 41, the angle between the illuminating lamp 42 and the pivot seat 41 can be adjusted by moving the illuminating lamp 42 along the direction shown by arrow (A) in FIG. 7 as required in order to vary the illuminated area.

As shown in FIG. 1 and FIG. 6, there are two ways of recharging the power storing unit 61 when the electricity stored therein is insufficient. The first method is by connecting the cigarette lighter socket of a vehicle to the power receptacle 62 via the cable 20 so as to permit charging of the power storing unit 61 by the direct current power source of the vehicle. The second method is by manually generating electricity, which is achieved in the following manner. The handle segment 722 of the drive arm 72 is first pivoted towards the left so as to be removed from the anchoring seat 34 of the housing 3. Then, the handle segment 722 is pivoted even further towards the left to bring the pivot segment 721 to a drive position t relative to the housing body 31, as illustrated in FIG. 1. At this point, the drive arm 72 can be manually operated to rotate relative to the housing body 31 by rotating the handle segment 722 either in the clockwise direction or in the counterclockwise direction. As a result of being driven by the drive arm 72, the power generating member 71 generates electricity that is to be stored in the power storing unit 61.

In this embodiment, the insect attracting and killing module 5 is designed to be telescopically coupled to the housing 3. However, the tubular fence 51 of the insect attracting and killing module 5 can also be designed to be fixedly coupled to the housing body 31 so as to be always at the extended position in other embodiments of the present invention.

In sum, since the illuminating lamp 42 is pivotable relative to the pivot seat 41 (and in turn, to the housing 3), the illuminating angle of the illuminating lamp 42 can be adjusted. In addition, the illuminating lamp 42 has an adjustable illuminating intensity. Therefore, the electric insect killer is provided with a proper illuminating capability. Further, by rotating the drive arm 72 relative to the housing 3, the power generating member 71 can generate electricity, which can be stored in the power storing unit 61. In addition, the power receptacle 62 can receive electricity from an external power source, such as the cigarette lighter socket of a vehicle. Therefore, the electric insect killer of the present invention does not require commercial AC power and can be conveniently used outdoors. Furthermore, the telescopic coupling design between the insect attracting and killing module 5 and the housing 3 can effectively reduce the overall size of the electric insect killer such that the electric insect killer can be easily stowed away. Moreover, by emitting light with various wavelengths, the ability of the light source 52 of the insect attracting and killing module 5 to attract insects increases significantly.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

I claim:

1. An electric insect killer comprising:
a housing;
an insect attracting and killing module coupled to said housing and including a light source for generating light to attract insects, and a high voltage grid unit surrounding said light source and operable to electrocute the insects attracted to said light source;
an illuminating module mounted on said housing for emitting illuminating light; and
a power supplying module mounted in said housing, and coupled electrically to said light source, said high voltage grid unit, and said illuminating module for supplying electric power thereto.

2. The electric insect killer as claimed in claim 1, wherein said insect attracting and killing module further includes a tubular fence coupled telescopically to said housing, said light source and said high voltage grid unit being mounted in said tubular fence.

3. The electric insect killer as claimed in claim 2, wherein said housing includes a housing body defining a mounting space, and a positioning member that is provided on said housing body and that extends into said mounting space; and
wherein said tubular fence includes a fence body that extends into said mounting space and that is movable into and out of said mounting space, and a first positioning part that is provided on said fence body to engage releasably said positioning member.

4. The electric insect killer as claimed in claim 1, wherein said illuminating module includes a pivot seat mounted to said housing, and an illuminating lamp connected electrically to said power supplying module, and pivoted to said pivot seat such that illuminating angle of said illuminating lamp relative to said pivot seat is adjustable.

5. The electric insect killer as claimed in claim 4, wherein said housing includes a housing body defining a mounting space, and two conductive pivot shafts that project from said housing body into said mounting space and that are connected electrically to said power supplying module,
said pivot seat of said illuminating module including a bowl-shaped seat body mounted in said mounting space, and two limiting ring parts projecting from said seat body and sleeved respectively on said conductive pivot shafts,
said illuminating lamp of said illuminating module having two pivot ring parts, each of which extends rotatably into a respective one of said limiting ring parts, and a pair of conductive contact parts, each of which is surrounded by a respective one of said pivot ring parts and contacts electrically a respective one of said conductive pivot shafts.

6. The electric insect killer as claimed in claim 5, wherein said housing further includes a pair of limiting plates that project from said housing body into said mounting space and that cooperate with said conductive pivot shafts to clamp said limiting ring parts, respectively.

7. The electric insect killer as claimed in claim 4, wherein said power supplying module includes a power storing unit mounted in said mounting space, and coupled electrically to said light source, said high voltage grid unit, and said illuminating lamp for supplying electric power thereto, and two on/off button switches mounted to said housing, accessible externally of said housing, and connected electrically to said power storing unit, one of said on/off button switches being further connected electrically to said illuminating lamp of said illuminating module, the other one of said on/off button switches being further connected electrically to said light source and said high voltage grid unit of said insect attracting and killing module.

8. The electric insect killer as claimed in claim 3, wherein said positioning member includes a mounting tube projecting from said housing body into said mounting space, an engaging element movably disposed in said mounting tube, and a biasing element received in said mounting tube and biasing said engaging element such that an end part of said engaging element extends out of said mounting tube, said first positioning part being formed with a first positioning groove to engage releasably said end part of said engaging element of said positioning member.

9. The electric insect killer as claimed in claim 8, wherein said tubular fence of said insect attracting and killing module further includes a second positioning part that is provided on said fence body to engage releasably said positioning member, said second positioning part being formed with a second positioning groove to engage releasably said end part of said engaging element of said positioning member,
said insect attracting and killing module being movable between a retracted position, where said tubular fence is concealed in said housing, and an extended position, where said tubular fence extends out of said housing,
said first positioning part engaging releasably said positioning member when said insect attracting and killing module is at the retracted position,
said second positioning part engaging releasably said positioning member when said insect attracting and killing module is at the extended position.

10. The electric insect killer as claimed in claim 1, wherein said light source of said insect attracting and killing module includes a plurality of light-emitting members for emitting different wavelengths of light.

11. The electric insect killer as claimed in claim 1, wherein said high voltage grid unit of said insect attracting and killing module includes a plurality of annular conductive grid elements that surround said light source, that are spacedly arranged along said light source, and that are connected electrically to said power supplying module.

12. The electric insect killer as claimed in claim 1, further comprising a frame member mounted on said housing and adapted to be disposed on a surface to thereby space apart said housing from the surface.
